(19) United States
(12) Patent Application Publication
(10) Pub. No.: US 2011/0099193 A1
(43) Pub. Date: Apr. 28, 2011

(54) AUTOMATIC PEDIGREE CORRECTIONS

(75) Inventor: Lee Samuel Jensen, Provo, UT (US)

(73) Assignee: Ancestry.com Operations Inc., Provo, UT (US)

(21) Appl. No.: 12/691,571

(22) Filed: Jan. 21, 2010

Related U.S. Application Data
(63) Continuation-in-part of application No. 12/605,999, filed on Oct. 26, 2009.

(51) Int. Cl. G06F 17/30

(52) U.S. Cl. 707/769; 707/E17.014; 707/802; 707/E17.044; 707/E17.005

(57) ABSTRACT

Systems, methods, and techniques are described for correcting pedigree information. A new pedigree record of a person may be received at a computer system. A stored pedigree record of a person may be selected if it is determined that the second person is likely to be the first person at some confidence level at or above a threshold confidence level. A comparison of data elements of the new pedigree record with data elements of the stored pedigree record may be conducted. A first data element of the new pedigree and a second data element of the stored pedigree that are not equivalent may be identified. An analysis as to which data element is more likely to be correct may be conducted. The incorrect data element may then be corrected with the correct data element.

### CROSS-REFERENCES TO RELATED APPLICATIONS

This application is a continuation-in-part of application Ser. No. 12/605,999, entitled Devices, Systems and Methods For Transcription Suggestions and Completions, filed on Oct. 26, 2009, attorney docket number 019404-003000US, the entire disclosure of which is hereby incorporated by reference for all purposes.

### BACKGROUND OF THE INVENTION

Volumes of records have been compiled in digital formats containing genealogical histories of persons and families. Such records may contain information as to where and/or when a person was born and/or died, and who a person's family is (including the person's parents, siblings, spouse(s), and children, etc.). This may be referred to as the person's “pedigree.” However, despite these large compilations of pedigree records, significant gaps may exist as to pedigrees of particular persons and/or families.

To cure these gaps, entities maintaining genealogical records may attempt to gather new records from various sources. For example, an outside source, such as a user or subscriber to a genealogical service, may submit an updated record regarding herself and/or her family. Such a submitted record may be based on the user's personal knowledge, derived from her family's oral history, gravestones (e.g., birthdates, dates of death, relationships), newspaper clippings (e.g., wedding announcements, obituaries, birth notices), to name only a few examples.

Such records submitted by a user may serve as valuable resources to fill gaps in personal and family pedigrees. In some instances, these records are the only available sources of such information. However, like any other source of information, inaccuracies may exist in these submitted records. Introduction of these inaccuracies to a database of compiled records may create significant problems, such as creating duplicate records referring to the same person with varying information (e.g., two persons having the same name from the same city, one listed as born in 1854, the other listed as born in 1845), or the modification of previously correct information in the database with incorrect information added by the user (e.g., a person was previously listed correctly as born in 1904; however a user-submitted record changes the date of birth incorrectly to 1906).

This invention serves to reduce the number of inaccuracies introduced to databases of genealogical histories and correct the inaccuracies based upon information already present in the database, among other purposes.

### BRIEF SUMMARY OF THE INVENTION

Systems, methods, and techniques are described for correcting and reconciling records containing pedigree information. A user may collect and compile pedigree information for himself and various other persons, possibly other family members from a variety of sources, such as the user's memory, family member's memories, family photographs, newspaper clippings, etc. This pedigree information may be submitted by the user to a central database as one or more records. While these sources of personal and family pedigree information may be valuable resources for information that would otherwise be unavailable, the sources may not be perfectly reliable due to inherently imperfect sources. While introduction of additional correct information to a genealogical database may beneficially expand the information available in the database, the introduction of incorrect information may result in supplanted correct information or the creation of multiple records with varying information for the same person. To prevent this, user-submitted records may be compared with records present in the database to determine if the persons in the user-submitted pedigree record are likely already represented in the database. If two records are located that are determined to represent the same person, the records may be reconciled.

The user may transmit a pedigree record containing pedigree information for one or more persons to a host computer where a large database of pedigree records for various people is maintained. Each pedigree record may contain a number of data elements for each person, such as his date of birth, date of death, surname, given name, etc. After receipt of this record, the data elements pertaining to each person in the received pedigree record may be compared with stored pedigree records corresponding to other persons already present in the database. One or more stored pedigree records of various persons may be selected if it is determined that they contain a person “similar” to a person present in the received pedigree record. A more detailed comparison between the similar records may be performed to determine if the records likely represent the same person. If they are determined likely to represent the same person, comparable data elements that do not match (e.g., varying birthdates) may be identified. An analysis may then be conducted to determine which of the data elements are more likely to be correct. The incorrect data element may then be corrected with the correct data element.

In some embodiments, a method for correcting pedigree information is described. The method includes providing a computer system, wherein the computer system comprises a computer-readable storage device. The method may also include receiving a new pedigree of a first person. The method may further include selecting a stored pedigree of a second person stored in a database at the computer system, wherein the second person is determined likely to be the first person at a confidence level at or above a threshold confidence level, and the stored pedigree of the second person is selected from a first plurality of stored pedigrees. Also, the method may include comparing data elements of the new pedigree of the first person with data elements of the stored pedigree of the second person. The method may include identifying a first data element of the new pedigree and a second data element of the stored pedigree that are not equivalent. Also, the method may include analyzing whether the first data element of the new pedigree or the second data element of the stored pedigree is more likely to be correct. The method may further include determining the second data element of the stored pedigree is more likely to be correct. Further, the method may include replacing the first data element of the new pedigree with the second data element of the stored pedigree, thereby creating a modified new pedigree. Moreover, the method may include storing the modified new pedigree.

In some embodiments of the invention, a method for correcting pedigree information is described. The method may include providing a computer system, wherein the computer system comprises a computer-readable storage device. The method may also include receiving a new pedigree record, wherein the new pedigree record is created by a user remote from the computer system and contains pedigree information for at least a first person. The method may further include comparing the new pedigree record to a plurality of other pedigree records stored at the computer-readable storage device of the computer system, wherein the other pedigree records contain information about a plurality of persons. The method may include selecting a group of pedigree records of persons similar to the first person of the new pedigree record based on the comparison of the new pedigree record with the plurality of other pedigree records. Further, the method may include comparing the new pedigree record and the group of pedigree records of similar persons, wherein the group of pedigree records of similar persons includes a pedigree record for a second person. The method may include determining the first person is the same as the second person. Further, the method may include identifying a first comparable data element linked to the first person in the new pedigree record that does not match a second comparable data element of the second person in the stored pedigree record. Moreover, the method may include identifying a likely correct comparable data element.

In some embodiments of the invention, a computer-readable storage medium having a computer-readable program embodied therein for directing operation of a computer system, including a processor and a storage device, wherein the computer-readable program includes instructions for operation of the computer system to correct pedigree information is described. The method may include receiving a first pedigree record including data elements linked to a first person. The method may include identifying a second pedigree record including data elements linked to a second person from a first plurality of stored pedigree records as being similar to the first pedigree record. The method may include identifying a data element within the first pedigree record that does not match a comparable data element within the second pedigree record. The method may include performing an analysis to determine a likely correct data element for the data element that does not match. The method may also include identifying a confidence level that the likely correct data element is correct.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a simplified block diagram of an embodiment of a system for correcting pedigrees.

FIG. 2 illustrates a simplified embodiment of a record of a user-submitted pedigree for a family.

FIG. 3 illustrates a simplified embodiment of a stored pedigree for a family.

FIG. 4 illustrates an embodiment of a method for correcting a pedigree record.

FIG. 5A illustrates an embodiment of a method for comparing pedigree records to determine if they likely refer to the same person.

FIG. 5B illustrates an embodiment of a continuation of the method of FIG. 5A.

### DETAILED DESCRIPTION OF THE INVENTION

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent, however, to one skilled in the art that other embodiments of the present invention may be practiced without some of these specific details. In other instances, well-known structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. While the following description refers to the correction of pedigree data in genealogical records, those with skill in the art will recognize that it may be applied to any record/database system.

Embodiments of the invention provide solutions (including without limitation, devices, systems, methods, software programs, and the like) for correcting pedigree records of persons and/or families based upon other stored pedigree information. In some embodiments of the invention, a user, who may be an amateur genealogist, subscriber to a genealogy service, or other party providing pedigree information, may submit pedigree information regarding himself, his family, and/or some other person and/or family. While this pedigree information may contain useful data that could be used to fill gaps in a compilation of pedigree information, if the pedigree information submitted by the user is incorrect, it may adversely impact the database. For example, if a new pedigree record is submitted containing a person with incorrect information, such as an incorrect birthdate, this may result in several problems. First, it may result in a duplicate record being created for the person. (In this instance, one record is created with the correct birthdate, while one record with the incorrect birthdate is created.) Therefore, two (or more) records may exist for the same person, potentially confusing genealogists and/or other users. Second, it may result in correct information in the database being supplanted with incorrect information.

In some embodiments, a record submitted by a user (or some other person) is compared to one or more records present in the database. A search of the database is conducted to identify similar records. Similar records may be identified as having a minimum number of matching data elements with the submitted record. Among the similar records, a deeper analysis may be performed in an attempt to determine whether one or more of these similar records (possibly dozens or hundreds) likely refers to the same person as the record submitted by the user. Such analysis may take into account that certain pieces of information, or data elements contained in the record, may not be equivalent to a corresponding data element in the stored record. Based upon the submitted record, the stored record (identified as likely referring to the same person), and other related records (e.g. parent, children, siblings, etc.) available in a database, a determination may be possible to be made as to whether data elements present in the stored record and/or the submitted record are correct. Substitution of the data elements determined to be correct for incorrect data elements may be completed by a computer system without human intervention, may be presented to an agent working on behalf of the entity maintaining the database, or may be presented to the user who submitted the new record for confirmation.

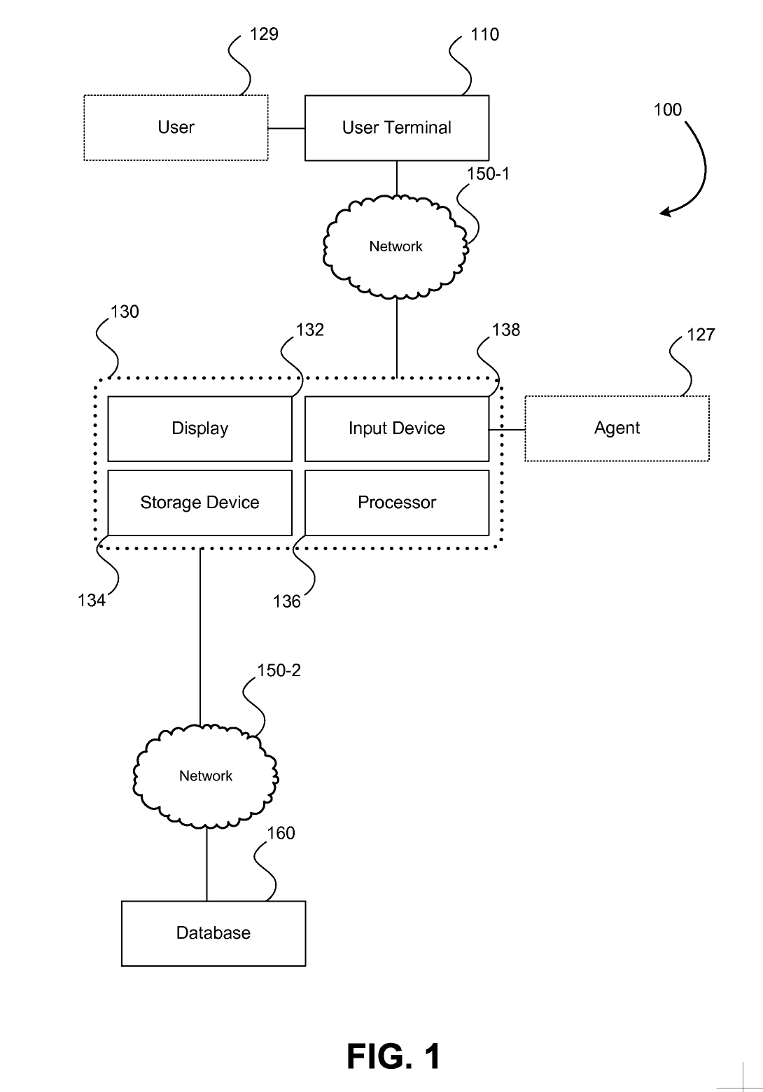

Such embodiments may employ a system such as that illustrated in FIG. 1. FIG. 1 illustrates a simplified block diagram of a system for receiving, analyzing, and modifying records, such as genealogical records. Such a system 100 may include: a computer system 130 (including a display 132, a storage device 134, input device 138, and a processor 136) and a database 160 which may be accessed over a network 150-2. In such a system, one or more records may be received from a user terminal 110 over network 150-1. The record or records may contain information regarding the pedigree of one or more persons and/or families. By way of example only, pedigree information for a person may include his or her date of birth, date of death, age at death, given name(s), surname(s), names and numbers of siblings, parents' names, names and number of children and/or grandchildren, etc. As those with skill in the art will recognize, any information pertinent to a person's history and/or family tree may be used. Also, those with skill in the art will recognize that while the description focuses on genealogy-specific data, the invention may be adapted for other forms of information and records.

The computer system 130 may be a server-based system, or may be a desktop-based system. In some embodiments, a human, such as an agent 127 working on behalf of the entity maintaining the database, may interact with the computer system using an input device 138 and the display 132, which may be a computer screen. The computer system 130 may receive records from the user terminal 110 directly, or may receive the records via a network 150-1. While FIG. 1 illustrates only a user terminal 110 as a possible way of a user submitting records, other distribution devices and methods may be used, such as portable computer-readable storage devices, including flashdrives and DVDs. The network 150-1 may be a private network, such as a private intranet, or a public network, such as the Internet. The computer system may have a storage device 134. Such a storage device 134 may be a hard drive, flash drive, random access memory, and/or any other device capable of storing digital data.

The computer system 130 may access the database 160 directly. For example, the database 160 may reside on the storage device 134 of computer system 130. Alternatively, the database 160 may reside at another computer, a server (or another server) and be accessible by multiple computers. The database 160 may be accessed via a network 150-2. The network 150-2 may be public, such as the Internet, or private, such as a private intranet. The network 150-2 may be the same network as network 150-1. Alternatively, the network 150-2 used to access the database 160 may be a network (such as an intranet) different from the network 150-1 (such as the Internet) used to interact with the user terminal 110.

The computer system 130, upon receiving a record from user terminal 110 (or some other distribution device and/or method) operated by a user 129, may analyze the record for persons similar to persons already described in the database 160. The computer system 130 may reformat and/or reorganize records submitted by the user 129. Beyond comparing records submitted by the user 129, the computer system 130 may add records to the database 160. The database 160 may be continuously updated with submitted records or may be updated periodically through batch processes.

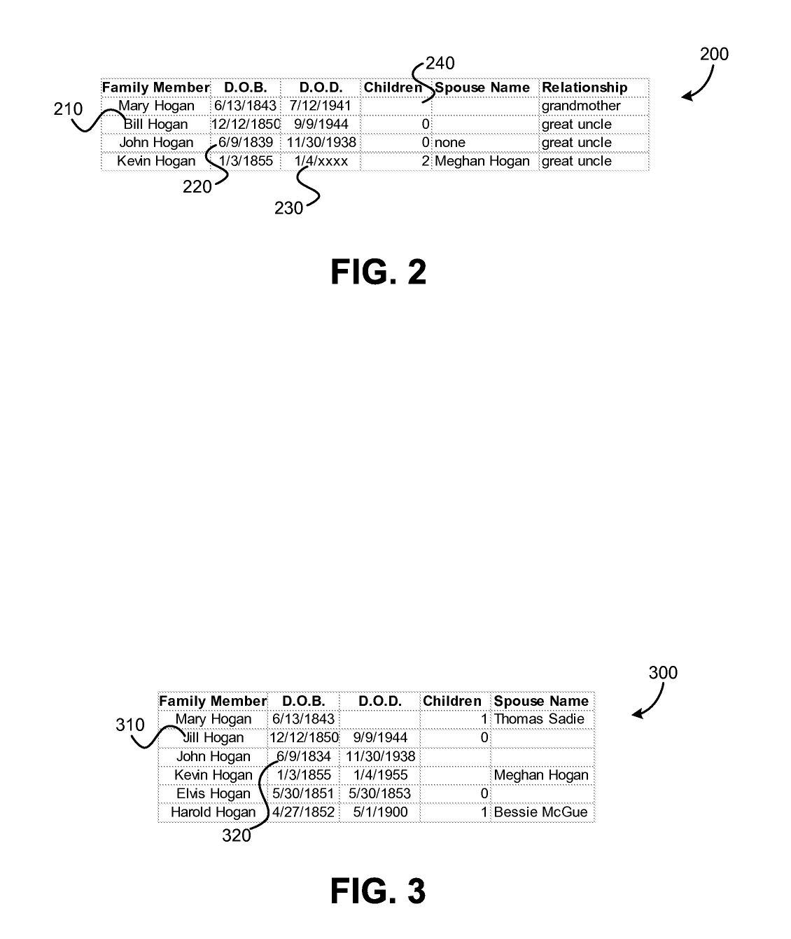

FIG. 2 illustrates an embodiment of a record 200 that may be submitted by a user, such as from user terminal 110 of FIG. 1, or from some other location and/or device. Such a record may contain pedigree information for one or more persons. For each person, one or more data elements may be present within the record. For example, in the embodiment of FIG. 2, each person has five associated data elements: a date of birth, a date of death, a number of children, a spouse's name, and a relationship element to describe the submitter's relationship to the person listed. As those with skill in the art will recognize, these data elements are only mere examples of possible categories of information that may be collected regarding the pedigree of a person. Further, with such information coming from a user, the information is not perfectly reliable. For example, error may be introduced through typographical errors, or the user's source for the information is incorrect. Also, the user may submit a record that contains incomplete information. This may be due to the user not having complete information. For example, in FIG. 2, Mary Hogan's number of children 240 has been left blank. Additionally, a data element may be submitted with incomplete information, such as Kevin Hogan's date of death 230. Two particular data elements have been noted in FIG. 2 for future reference: the name Bill Hogan 210 and the birthdate of John Hogan 220.

Record 200 illustrates only one possible example of an embodiment of a user-submitted record. For example, in some embodiments, a user may provide similar pedigree information via a web-based interface, via a spreadsheet, via a paper-based form, or any other method sufficient to gather data from a user. Additionally, a user may be required to state his source for the information. For example, more credibility may be given to pedigree information gathered from “a printed wedding announcement” than “grandmother's memory.”

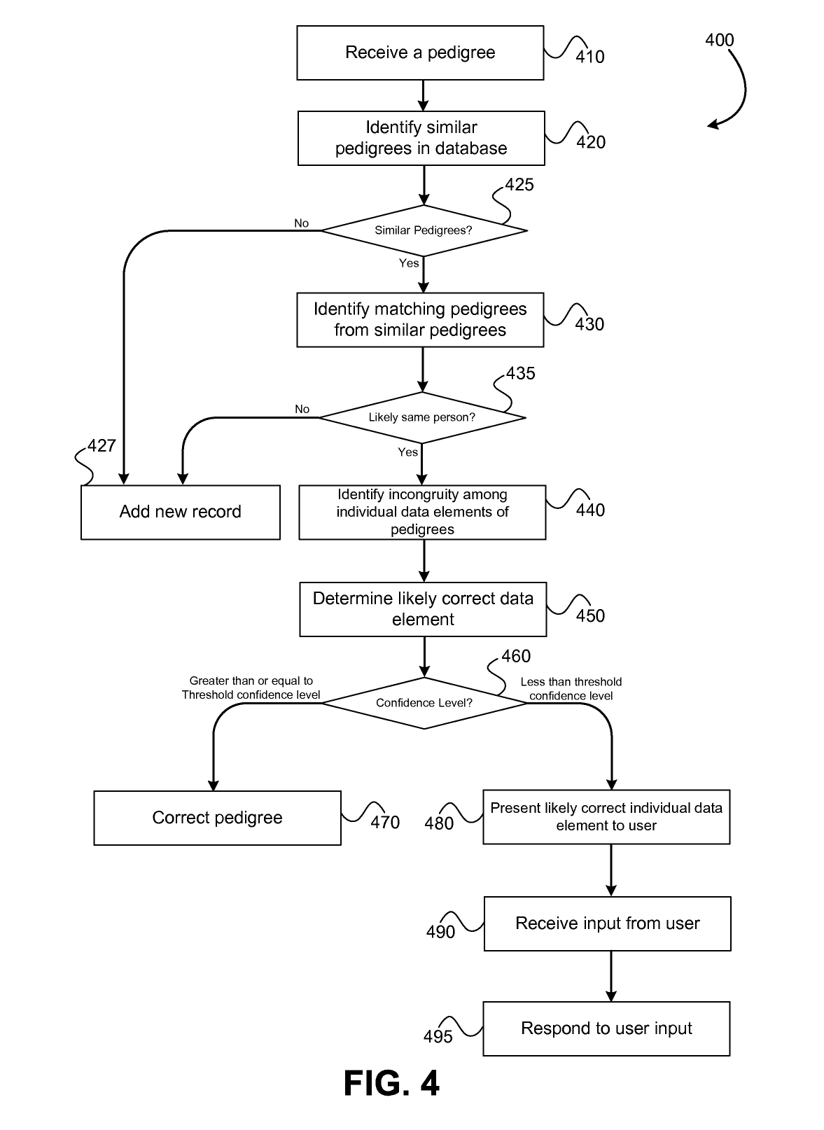

FIG. 3 illustrates a possible embodiment of a record containing pedigree information stored in a database. This database may be database 160 of FIG. 1, or may be some other database. The record 300 of FIG. 3 may contain less, more, or similar information to the record 200 of FIG. 2. In comparing the embodiment of record 200 of FIG. 2 and the embodiment of record 300 of FIG. 3, several key differences exist. First, record 300 does not contain data elements corresponding to personal relationships as present in FIG. 2. Record 300 may contain fewer, more, and/or different data elements regarding the pedigree of persons then records submitted by users, such as record 200 of FIG. 2. Also, the name Jill Hogan 310 does not match with the name Bill Hogan 210 of FIG. 2. Similarly, the birthdate of John Hogan 320 (Jun. 9, 1834) does not match the birthdate of John Hogan 220 of FIG. 2 (Jun. 9, 1839). By inspection of these two records alone, it may not be possible to ascertain whether data element 210 or 310 is correct or whether data element 220 or 320 is correct. In some embodiments, an assumption may be made that data elements already present in the database are correct. In such an embodiment, the user-submitted record may be corrected or ignored. In other embodiments, no such assumption may be made as data elements in a record submitted by a user may replace data elements present in a record stored in the database if they are more likely correct.

Also, as record 300 is illustrated in FIG. 3, certain data elements are missing: Mary Hogan does not have a date of death, “Jill” (or possibly “Bill”) Hogan and Kevin Hogan do not have numbers of children listed. Therefore, the submission of record 200 of FIG. 2 by a user may be useful despite it being incomplete and (possibly) containing a number of inaccurate data elements.

When a user submits a record, such as record 200 of FIG. 2, an initial search may be conducted of the database to locate similar pedigree records. The search may consist of identification of matching data elements, with the records having the most matching data elements, or more data elements than a threshold number, considered “similar.” For example, if the user submitted the record 200 of FIG. 2, a search of the database may be conducted for each of the four persons listed. A search of the first person listed, Mary Hogan, would result in a match of at least two data elements in a database: her name, and her date of birth. However, certain incongruities exist between the record of Mary Hogan in record 200 and the record of Mary Hogan in record 300 of FIG. 3. In record 200 there is no number of children listed, and no spouse name listed. In record 300 of FIG. 3, no date of death is listed. Despite these differences, no data element conflicts with a data element from the other record. A comparison of the pedigree record for Mary Hogan in record 200 of FIG. 2 and the pedigree record for Mary Hogan in record 300 of FIG. 3 may result in determination that they are likely the same person. Therefore, data elements present in record 200 of FIG. 2 for Mary Hogan that are not present for Mary Hogan in record 300 of FIG. 3 may be used to augment the database. In this case, the date of death of Mary Hogan may be added to the record 300 of FIG. 3.

A different situation exists for Bill Hogan 210 of record 200 of FIG. 2 and Jill Hogan 310 of record 300 of FIG. 3. The submission of record 200 by a user may result in the pedigree record of Jill Hogan being identified as similar to the pedigree record of Bill Hogan due to the same last name, the same date of birth, the same date of death, and the same number of children being present. An analysis of these two records may result in a determination that Bill Hogan 210 is likely the same person as Jill Hogan 310. Further analysis may be conducted in an attempt to determine whether the correct first name is Bill or Jill. This may involve an analysis of the trustworthiness of the records identifying them as Jill or Bill, or may look to other records where the person may be mentioned (such as listed as a sibling for another person). If, after analysis, Bill Hogan is determined to be correct, the name Jill Hogan 310 of record 300 may be substituted with Bill Hogan 210 of record 200. Alternatively, if Jill Hogan 310 is determined to be the correct name, the record 200 for Bill Hogan 210 may be modified to contain the correct name, or the record for Bill Hogan 210 submitted by the user may be ignored.

A similar analysis may be conducted regarding John Hogan of record 200 and record 300. Initially, the pedigree record of John Hogan of record 300 may be identified as similar to the record for John Hogan of record 200 due to matches of his first name, last name, and date of death. An incongruity may be noted between John Hogan's date of birth 220 of record 200 and John Hogan's date of birth 320 in record 300. An analysis may be conducted to determine that the John Hogan of record 200 is likely to be the same John Hogan of record 300. It may be necessary to consider that more than one John Hogan existed (this may be especially necessary for persons with common names). Again here, based on the name and the date of death being an exact match, a determination may be made that the John Hogan of record 200 is the same John Hogan of record 300. Another analysis may be conducted to determine whether the date of birth 220 listed for John Hogan or the date of birth 320 for John Hogan is correct (or that neither are correct). Again here, this may involve looking at other related records, such as for family members, or official birth records, to name only two examples. The analysis may consider that the date of birth for John Hogan 320 present in record 300 was previously gathered from a city's birth certificate depository while the date of birth 220 for John Hogan of record 200 was from a relative's memory. Based on this difference in source for the birthdates, an assumption may be made that official records are more reliable than a person's memory (or vice versa).

If Jun. 9, 1834, is determined to be John Hogan's birthday, the birthdate 220 of John Hogan in record 200 may be corrected. In some embodiments, the user who submitted record 200 may be notified of the change, or may be prompted to make the change to the date of birth 220 of John Hogan. In some embodiments, the discrepancy would be presented to an agent working on behalf of the entity maintaining the database for the agent to review and/or confirm the substitution. Whether the substitution is performed by the computer system without human intervention or requires presentation of the substitution to the user and/or the agent may be determined based on a confidence level determined by the analysis of the records. If the confidence level is greater than some threshold confidence level (possibly set by the agent), the substitution may be made without human intervention. If the confidence level is below the threshold confidence level this may result in either the user or the agent being prompted to select the correct date of birth, or no correction being performed.

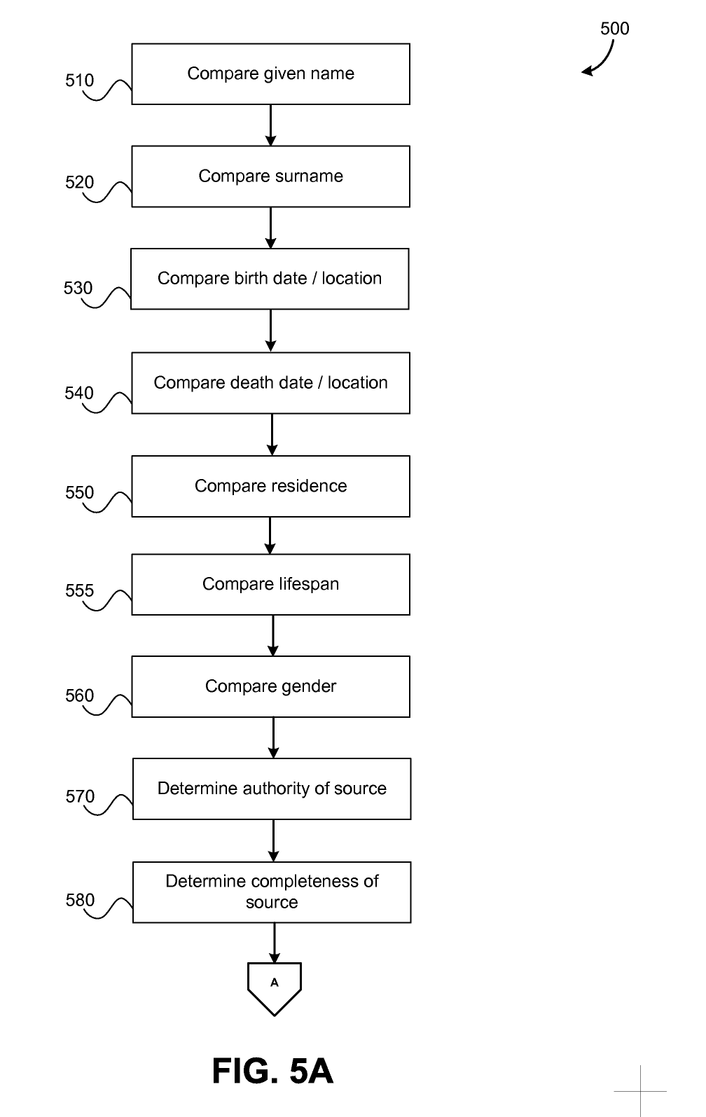

The record of FIG. 2 may be compared and analyzed against one or more records, such as record 300 of FIG. 3, according to a method, such as method 400 of FIG. 4. FIG. 4 illustrates a method 400 for receiving, analyzing, and correcting pedigree records. At block 410, a pedigree record is received. The pedigree record may be received at a computer system, such as computer system 130 of FIG. 1. In other embodiments, some other computer system may be used. The pedigree received at block 410 may be received from a user in the form of an electronic file. This may be a spreadsheet, a text file, data entered into a web-based form, a paper form (possibly sent through the mail, or scanned and sent electronically), or any other form of data transmission. This pedigree may contain pedigree information for one person or for multiple persons. These persons may include the user herself and/or members of her family. The persons included in the pedigree may also have no relation to the user who submitted the pedigree record. For each pedigree record of a person, a number of data elements may be present. For example a pedigree record for “John Doe” may include data elements, such as his date of birth, date of death, number of children, and names of siblings, to name only a handful of examples.

Following receipt of the pedigree records at block 410, the persons contained in the record may be compared to persons and/or records already present in the database. Such a comparison may involve identifying all of the records (possibly one other record, possibly dozens or hundreds) in the database pertaining to persons with similar pedigrees at block 420. Alternatively, a search may be limited to groups of people based on a geographic area, time period, ethnicity, or any other factor. The identification of block 420 may be a simple comparison of data elements within pedigree records to identify similar pedigree records in the database. This may be accomplished by determining the number of data elements present in the pedigree record of the person submitted that match data elements present in pedigree records stored in the database. For example, if two or more data elements of a record pertaining to a person match, the records may be considered “similar.” The number of data elements that must match for records to be considered similar may be adjustable by an agent or a user.

Additionally, the proximity of data elements may be evaluated. This may involve evaluating various distance-based metrics. For example, while names associated with pedigree records may not be identical matches, this does not necessarily mean that the records refer to different persons. For example, a first record may refer to a person named “James Brian Hope.” A record submitted by user may refer to “Brian Hope.” While these names may not qualify as matches, a search incorporating a proximity evaluation may consider these records similar because the first name in the first record is Brian, and the middle name in the second record is Brian. Therefore, the name Brian may be considered in close proximity in both records. Other examples of distance-based metrics that may be evaluated include phonetic difference (e.g., “Bryan” and “Brian”), abbreviated representations (e.g., “wm” and “William”), initials (e.g., “JFK” and “John Fitzgerald Kennedy”), and common characters edit distance (e.g., “Joesph” and “Joseph”).

Whether based on matches and/or proximity, the comparison may result in a number of similar records being identified. If similar pedigree records are identified at block 425, the method may proceed to block 430. The maximum number of returned similar results may be set by an agent or user. The number of returned results may vary based on the number of similar records identified during the search. If no similar records exist, a new record may be added to the database at block 427 based on the pedigree provided by the user at block 427.

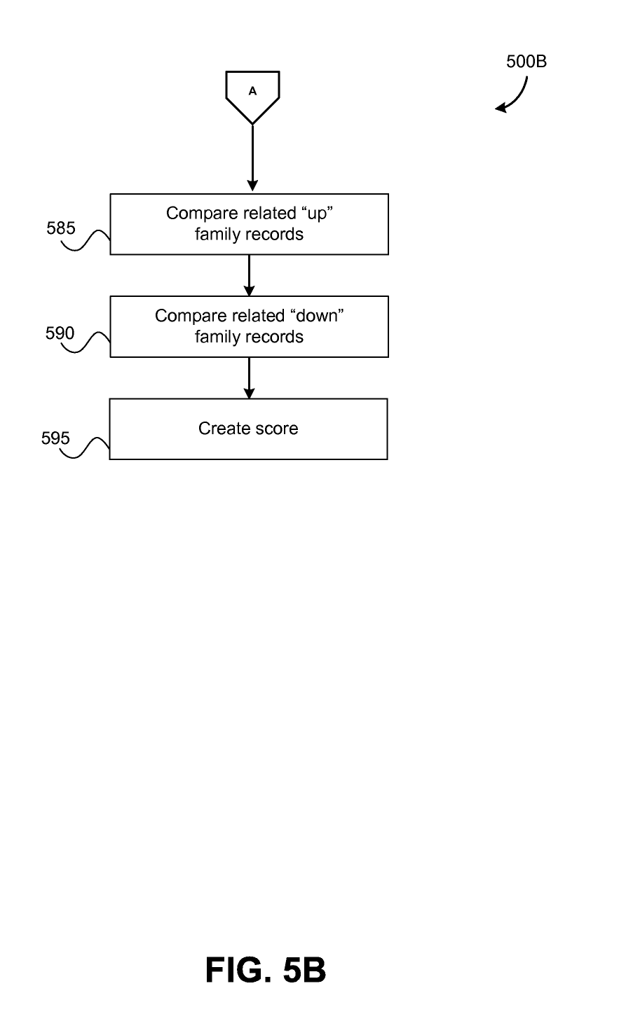

Following the identification of similar pedigree records at block 420, a deeper analysis may be performed at block 430 to compare the similar pedigree records to the received pedigree record to determine if they likely refer to the same person. Details of possible embodiments of this analysis will be discussed later in reference to FIG. 5A. If it is determined that none of the similar pedigree records likely refer to the same person as the received pedigree at block 435, a new record based on the received pedigree may be added to the database at block 427. If one or more records in the database is determined to likely refer to the same person as the received pedigree at block 435, the method may proceed to block 440. The determination of whether records are considered to refer to the same person or different persons may be based on a score (or confidence level) determined during the analysis at block 430. For example, for two records to be determined as referring to the same person, a certain threshold confidence level may need to be met or exceeded.

Following two or more records being identified as likely referring to the same person, incongruities in comparable data elements (e.g., the birthdates in each record) between the two or more records may be identified at block 440. This may involve the identification of none, one, or more comparable data elements that are not equivalent. If no incongruities are present, the method may end. However, if there are incongruities between data elements in the received record and the one or more records identified as pertaining to the same person, the method may proceed to block 450.

At block 450, a determination may be made as to the likely correct data element. This determination may include a statistical analysis being conducted. A possible form of statistical analysis may involve evaluating the number of records that corroborate the data element. As a simple example of such a statistical analysis, if 100 records relate to the same person, with 90 spelling the person's name “Bryan” and the remainder spelling it “Brian,” the ratio of “Bryan” to “Brian” would be 10:1. Such a ratio may result in a score of 0.9. This score may be used to determine that “Bryan” is likely the correct data element.

Another factor possibly used at block 450 to determine the likely correct data element is completeness. One instance where completeness may be used to determine the likely correct data element is where roughly equal numbers of records contain data that does not conflict, but have varying levels of completeness. For example, the data elements may be a birthdate of “Jun. 13, 1942” and a birthdate of “June 1942.” While the birthdates do not conflict, the former is more complete and specific. In such an instance, a smaller number of records that contain the more specific date of Jun. 13, 1942 may be selected over June 1942, due to the completeness of the data element.

In some embodiments, a statistical analysis may include evaluating the credibility of the source the data element of the received pedigree record is based upon and the source of the data elements of the one or more pedigree records in the database is based upon. In some embodiments, it is assumed that data elements already present in a record in the database are correct. In other embodiments, it is assumed that data elements submitted by a user are correct. In still other embodiments, a confidence level of the likely correct data element is determined. The confidence level may identify the likelihood that a data element, identified as being likely correct, is in fact correct. For example, a confidence level may range from 0 to 1, with a confidence level of near 1 being a high likelihood that the data element is correct, while a confidence level near 0 may indicate the data element is less likely to be correct.

Another factor that may be considered during an analysis at block 450 is statistical significance. While various records may conflict regarding a data element, it may not be possible to eliminate one or more as being incorrect. Rather, until a statistically significant difference is found (e.g., 10 records regarding the same person containing a particular data element, while only 1 contains a differing data element), both data elements may be considered possibly valid.

At block 460, this confidence level may be compared to a threshold confidence level. This threshold confidence level may be defined by a user or an agent of the entity maintaining the database. If the confidence level is identified as being greater than the threshold confidence level at block 460, the pedigree records identified as being incorrect may be updated with the correct data element at block 470. This process may happen without human interaction (whether it be by the user or by an agent of the entity maintaining the database). If the confidence level is below the threshold confidence level at block 460, this may indicate that a person must verify that the data element identified as likely to be correct should replace the likely incorrect data element.

At block 480, the user (who may have initially sent the pedigree record), or an agent working on behalf of the entity maintaining the database, may be presented with the data element identified as likely being correct for confirmation that it should replace the likely incorrect data element. This may involve the user or agent being presented with the received pedigree record and the pedigree record from the database for comparison. It may also involve the user or agent being presented with information gathered during the statistical analysis conducted at block 450.

At block 490, the user may input whether the data element identified as being likely correct should replace the likely incorrect data element. In some embodiments, the user or agent may have the ability to input some other data element or may be able to select a data element from a list of choices. Based upon this input, the incorrect data element of the pedigree record may be corrected at block 495. Block 495 may refer to the correction of one or more pedigree records in the database or may refer to the correction of the pedigree record provided by the user at block 410. If the pedigree provided by the user is corrected, this may involve the user being so notified, such as via a transmission to the user's computer or an e-mail.

FIG. 5A illustrates an embodiment of a method 500 for analyzing pedigree records to determine if multiple pedigree records likely represent the same person. Method 500 may be used to identify matching pedigrees from similar pedigree records in situations such as block 430 of FIG. 4. Method 500 may include comparing the given name of the person in the received pedigree record with the given name of the person in one or more stored pedigree records. This may include looking for exact matches. Besides looking for an exact match other factors regarding the given names may also be evaluated. The given names may be evaluated based on the number of terms in each name, cross-matching (e.g. matching “John Joseph” with “Joseph John”), initial matching (e.g., “Abraham Bryan Cain” would match “Adam Brent Callahan”), number of initials matching, term length matching (e.g., the same number of characters), phonetic matching (names sound alike but are spelled different), typographical similarities, backward matching, subset matching (e.g. “Will” would match “William”), cultural origin matching, prefix matching, suffix matching, title matching, and nickname matching. A name dictionary may also be used.

At block 520, similar comparison may be conducted using the surname of the person in the received pedigree record and the one or more stored pedigree records. It may involve using a similar evaluation of terms, matching techniques, and evaluation as described in reference to block 510.

Next, at block 530, the birthdate associated with the records may be compared. This may involve analyzing whether the entire event (the day, month, year) or a portion of the event (e.g., the day and month, but not the year) match. The comparison may also look at each element individually such as whether the year matches, whether the month matches, or whether the day matches. The analysis may further look at the “distance” (in other words, the time period) between the date listed in the stored pedigree record in the date listed in the received pedigree record. Also, the analysis may include looking at the probability that the date listed in the received pedigree record was intended to match the date present in the one or more stored pedigree records. Also an analysis may be conducted on the location of the birth. The one or more stored pedigree records and the received pedigree record may be compared for whether the country, state, county, and/or city match. The places may be evaluated for typographical similarities, phonetic similarities, whether the two places are historical matches, whether the places are adjacent, and/or the probability that the place in the received pedigree record was intended to match the place of the one or more stored pedigree records. The analysis may also include an evaluation of distance between the place listed in the received pedigree record and the place in the one or more stored pedigree records.

At block 540, a comparison may be conducted between the stored pedigree record(s) and the received pedigree record based on the date and location of the person's death. This may involve a similar analysis as described in relation to block 530 for the person's birth date and location.

At block 550, the residences associated with the person of each record may be compared. This comparison may include an analysis similar to that described for the person's birth location.

At block 555, the lifespan of the person of the stored pedigree record(s) may be compared to the lifespan of the person in the received pedigree record. Information pertaining to the lifespan may be based upon a known life span, such as if the person's birthdate and death date are known, or may be inferred, based on residence information, marriage information, etc.

At block 560, the gender of the persons associated with each record may be evaluated for an exact match.

At block 570, the credibility of the sources of the information for the data element of the stored pedigree record(s) and the data element of the received pedigree record may be evaluated. Certain credibility may be given to particular sources of information. For example, official records may be given a certain credibility score, with newspaper clippings being given a lower credibility score, and with a still lower credibility score being given to a person's memory. The credibility score assigned to various sources may be adjusted by an agent of the entity maintaining the database.

At block 580, the completeness of the sources for the data elements of the received pedigree record and the stored pedigree record(s) may be evaluated. This may include an evaluation of how much information about the person is present in the source. For example, less credibility may be given to a source that in passing mentions that the person was born on a particular date, in comparison to a source that lists the person's birthdate, names of parents, place of residency, and siblings' names.

The method 500 of FIG. 5A may continue with the method 500B of FIG. 5B. Records within the family of the person related to the stored pedigree record(s) and the received pedigree record may be utilized to improve the comparison. The comparison may look “up” for attributes relevant to the record in question at block 585. This look “up” refers to examining pedigree records of the person's parents and siblings. For example, if a person's birthdate is in question, a comparison “up” of the person's family tree may look at the mother and father's pedigree records to determine when they are listed as having had children.

The comparison may also involve looking “down” for related attributes at block 590. This look “down” refers to looking at pedigree records of the person's spouse(s) (possibly including the spouse's mother and/or father), marriage, and children. Certain information regarding family members may be inconclusive for matching purposes (for example, if a person is alive, the number of children the person has had may change over time). Such information may only be used if a match is made, and may be ignored otherwise.

Based upon the results of the individual attributes (those related only to the person associated with the record in question, e.g. birthdate, name, etc.) and the family attributes (those related to other family members, both “up” and “down” a family tree) may be combined to create a score at block 595. This score may influence how likely a pedigree record of a person identified as being similar from the database is likely to actually relate to the same person present in the received pedigree record. This score may be referred to as a confidence level.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. Methods and processes may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention. Further, as mentioned previously, while the invention has been described in terms of genealogical records, the invention may be used for other forms of records and databases. For example, records relating to historical events, country demographics, physical elements, or cars may represent other possible categories of records the invention may be applied to.

What is claimed is:

1. A method for correcting pedigree information, the method comprising:
providing a computer system, wherein the computer system comprises a computer-readable storage device;
receiving, at the computer system, a new pedigree of a first person;
determining, at the computer system, a stored pedigree of a second person stored in a database at the computer system is likely to represent the first person at a confidence level at or above a threshold confidence level, and the stored pedigree of the second person is selected from a first plurality of stored pedigrees;
comparing, at the computer system, data elements of the new pedigree of the first person with data elements of the stored pedigree of the second person;
identifying, at the computer system, a first data element of the new pedigree and a second data element of the stored pedigree that are not equivalent;
analyzing, at the computer system, whether the first data element of the new pedigree or the second data element of the stored pedigree is more likely to be correct;
determining, at the computer system, the second data element of the stored pedigree is more likely to be correct;
replacing, at the computer system, the first data element of the new pedigree with the second data element of the stored pedigree, thereby creating a modified new pedigree; and
storing, at the computer system, the modified new pedigree.

2. The method of claim 1, further comprising, prior to selecting the stored pedigree of the second person, selecting, at the computer system, the first plurality of stored pedigrees from among a second plurality of stored pedigrees.

3. The method of claim 2, wherein selecting, at the computer system, the first plurality of stored pedigrees from among the second plurality of stored pedigrees, involves evaluating a number and a proximity of matching data elements in each pedigree of the stored pedigrees of the second plurality of stored pedigrees with the new pedigree.

4. The method of claim 1, wherein the threshold confidence level is adjustable by an agent on behalf of an entity maintaining the database stored on the computer system.

5. The method of claim 1, wherein the new pedigree includes pedigree information for multiple persons.

6. The method of claim 1, wherein the new pedigree is provided by a user, wherein the user is not an agent of the entity maintaining the database.

7. The method of claim 1, wherein the selection of the stored pedigree of the second person stored in the database includes comparing a given name of the second person to a given name of the first person.

8. The method of claim 7, wherein the selection of the stored pedigree of the second person stored in the database further includes comparing a surname of the second person to a surname of the first person.

9. A method for correcting pedigree information, the method comprising:
providing a computer system, wherein the computer system comprises a computer-readable storage device;
receiving, at the computer system, a new pedigree record, wherein the new pedigree record is created by a user remote from the computer system and contains pedigree information for at least a first person;
comparing, at the computer system, the new pedigree record to a plurality of other pedigree records stored at the computer-readable storage device of the computer system, wherein the other pedigree records contain information about a plurality of persons;
selecting, at the computer system, a group of pedigree records of persons similar to the first person of the new pedigree record based on the comparison of the new pedigree record with the plurality of other pedigree records;
comparing, at the computer system, the new pedigree record and the group of pedigree records of similar persons, wherein the group of pedigree records of similar persons includes a pedigree record for a second person;
determining, at the computer system, the first person is the same as the second person; and
identifying, at the computer system, a first comparable data element linked to the first person in the new pedigree record that does not match a second comparable data element of the second person in the stored pedigree record; and
identifying, at the computer system, a likely correct comparable data element.

10. The method of claim 9, wherein comparing the new pedigree record with the plurality of other pedigree records stored at the computer-readable storage device of the computer system involves evaluating a number of matching comparable data elements in each pedigree of the plurality of other pedigree records with the new pedigree record.

11. The method of claim 9, further comprising determining, at the computer system, a confidence level of the likely correct comparable data element.

12. The method of claim 9, further comprising presenting, at the computer system, the likely correct individual comparable data element to an agent of an entity maintaining stored pedigree records for integration into the new pedigree record.

13. The method of claim 9, further comprising:
determining, at the computer system, the confidence level is equal to or greater than a threshold confidence level; and
presenting, at the computer system, the likely correct individual comparable data element to an agent of an entity maintaining stored pedigree records for integration into the stored pedigree record.

14. A computer-readable storage medium having a computer-readable program embodied therein for directing operation of a computer system, including a processor and a storage device, wherein the computer-readable program includes instructions for operating the computer system to correct pedigree information, the instructions comprising instructions for:
receiving a first pedigree record including data elements linked to a first person;
identifying a second pedigree record including data elements linked to a second person from a first plurality of stored pedigree records as being similar to the first pedigree record;
identifying a data element within the first pedigree record that does not match a comparable data element within the second pedigree record;
performing an analysis to determine a likely correct data element for the data element that does not match; and
identifying a confidence level that the likely correct data element is correct.

15. The method of claim 14, further comprising:
comparing the first pedigree record to a second plurality of stored pedigree records;
determining a number and a proximity of matching data elements between the first pedigree record and each of the stored pedigree records of the second plurality; and
creating a first plurality of stored pedigree records from the second plurality of stored pedigree records based upon the number and proximity of matching data elements.

16. The method of claim 17, wherein the number of stored pedigree records in the first plurality is user-settable.

17. The method of claim 14, further comprising:
determining that the confidence level is equal to or greater than a threshold confidence level; and
replacing an incorrect data element within the received pedigree record with the likely correct data element.

18. The method of claim 14, further comprising:
determining that the confidence level is below a threshold confidence level; and
presenting the likely correct data element to a user to confirm replacement of an incorrect data element with the likely correct data element.

19. The method of claim 14, wherein the first pedigree record is transmitted to the computer system from a third-party user.

20. The method of claim 14, wherein the second pedigree record from a first plurality of stored pedigree records is identified as being similar to the first pedigree record comprising comparing the first person's ancestors with the second person's ancestors.
